(19) United States
(12) Patent Application Publication
(10) Pub. No.: US 2017/0023417 A1
(43) Pub. Date: Jan. 26, 2017

(54) THERMAL DISPLACEMENT COMPENSATION DEVICE FOR MACHINE TOOL

(71) Applicant: FANUC Corporation, Yamanashi (JP)

(72) Inventor: Yasuaki KOYAMA, Yamanashi (JP)

(21) Appl. No.: 15/211,283

(22) Filed: Jul. 15, 2016

(30) Foreign Application Priority Data
Jul. 21, 2015 (JP) 2015-144088

(51) Int. Cl. G01K 7/22; G06F 17/11; G05B 19/404

(52) U.S. Cl. CPC G01K 7/22; G05B 19/404; G06F 17/11

(57) ABSTRACT

A thermal displacement compensation device detects the temperature of a machine tool and the temperature of an environment in which the machine tool is placed, and estimates a temperature distribution in a machine component affected by the temperature of the environment from the relationship between the temperature of the machine tool and the temperature of the environment. Based on the estimated temperature distribution in the machine component, a position in the machine tool at which the time constant of the detected temperature matches the time constant of thermal displacement of the machine component affected by the temperature of the environment is found and set. Using temperature at the set position as a revised temperature of temperature detected by the machine temperature detection section, a thermal displacement amount of the machine component is calculated.

### BACKGROUND OF THE INVENTION

1. Field of the Invention

The present invention relates to a thermal displacement compensation device for a machine tool, and particularly to a thermal displacement compensation device for a machine tool which can accurately perform thermal displacement compensation with a small number of temperature sensors. 2. Description of the Related Art

In machine tools, a feed screw and a spindle are driven by motors. Accordingly, the spindle and the feed screw are expanded by heat generated by motors, frictional heat generated by the rotation of bearings, or frictional heat in a contact portion between a ball screw and a ball nut of the feed screw, and a machine position changes. Moreover, the temperatures of a column and a bed also change due to a change in temperature around the machine tool and the use of coolant, and elongation and inclination thus occurring cause a change in a machine position. Specifically, a shift occurs in the relative positional relationship between a workpiece to be positioned and a tool. Such a change in a machine position caused by heat becomes a problem in the case where high-precision machining is performed.

To eliminate such a machine position displacement caused by heat, the following techniques have been adopted: a technique to correct a commanded position using a displacement sensor, a technique to compensate a commanded position by estimating a thermal displacement from operating conditions such as the number of revolutions of a spindle, a structure which is not affected by expansion due to heat by giving an initial tension to a feed screw, and the like.

In particular, a method of predicting a thermal displacement based on temperature detected by a temperature sensor disposed at an important position on a machine tool has attracted attention because not only thermal displacements of a feed screw and a spindle but also thermal displacements caused by a change in ambient temperature and coolant can be compensated in real time. A thermal displacement amount AL according to this method can be expressed by the following equation (1):

ΔL=αLΔT (1)

where α is linear expansion coefficient, L is the length of a machine component, and ΔT is a change in temperature.

However, the above-described equation (1) is based on the assumption that there is a linear correlation between a thermal displacement amount and a change in temperature. However, when a temperature sensor is separated from a heat source, the time constant of thermal displacement differs from the time constant of temperature change, and therefore a thermal displacement amount cannot be correctly calculated based on the temperature sensor. As shown in FIG. 8, temperature at a position separated from a heat source slowly responds to a change in the temperature of the heat source, and the maximum value of the temperature is lowered by heat radiation. Accordingly, a method has been devised in which temperature detected by a temperature sensor is appropriately revised to match the time constant of change in the detected temperature with the time constant of thermal displacement (for example, see Japanese Patent Application Laid-Open Nos. 2002-086329, 2006-055919, 2008-183653, 2005-088126, and 08-174380).

In a technique disclosed in Japanese Patent Application Laid-Open No. 2002-086329, a temperature sensor is disposed in the vicinity of a heat source to match the time constant of thermal displacement with the time constant of detected temperature. However, in the case where an ambient temperature changes or a coolant is a heat source, heat is generated in a complex manner over a wide range on a machine. Accordingly, it is difficult to identify a heat source. Moreover, even if a heat source can be identified, a large number of temperature sensors are required. An increase in the number of temperature sensors increases costs (costs for installing temperature sensors themselves or a detection signal receiving unit) and a failure rate.

A technique disclosed in Japanese Patent Application Laid-Open No. 2006-055919 assumes that the difference between the time constant of thermal displacement and the time constant of detected temperature is small. In the case where the difference between the time constants is large, when thermal displacement occurs in a state in which a temperature change is not detected, the state occurring in an early stage of a transient state, an error becomes large.

A technique disclosed in Japanese Patent Application Laid-Open No. 2008-183653 can calculate a thermal displacement amount even in the case where a thermal displacement is produced in the above-described state in which a change in temperature is not detected. However, since spindle rotation speed and the amount of heat generated are associated with each other, a thermal displacement caused by heat generated in the spindle can be estimated, but other thermal displacements (thermal displacements caused by a change in ambient temperature and coolant) cannot be estimated.

Moreover, techniques disclosed in Japanese Patent Application Laid-Open Nos. 2005-088126 and 08-174380 require a plurality of temperature sensors for a single machine component, thus increasing costs and a failure rate.

### SUMMARY OF THE INVENTION

Accordingly, an object of the present invention is to provide a thermal displacement compensation device which can accurately perform thermal displacement compensation with a small number of temperature sensors even in the case where a thermal displacement is produced in a state in which a change in temperature is not detected.

The present invention relates to a thermal displacement compensation device for a machine tool which performs compensation with high accuracy by revising temperature data having a time constant different from that of a thermal displacement using environmental temperature when a thermal displacement is estimated using a temperature sensor.

A thermal displacement compensation device for a machine tool according to the present invention includes a machine temperature detection section configured to detect temperature of the machine tool, and is configured to perform thermal displacement compensation by calculating a thermal displacement amount based on change in temperature measured by the machine temperature detection section, setting an amount canceling out the calculated thermal displacement amount as a thermal displacement compensation amount, and adding the thermal displacement compensation amount to a position command for a feed shaft. The thermal displacement compensation device includes an environmental temperature detection section for detecting temperature of an environment in which the machine tool is placed; a temperature distribution estimation section for estimating a temperature distribution in a machine component affected by the temperature of the environment from a relationship between the temperature of the environment and the temperature of the machine tool; a setting section for finding, from the temperature distribution, and setting a position in the machine tool at which a time constant of the detected temperature matches a time constant of thermal displacement of the machine component affected by the temperature of the environment; and a thermal displacement amount calculation section for calculating a thermal displacement amount of the machine component using temperature at the position set by the setting section as a revised temperature of temperature detected by the machine temperature detection section.

The environmental temperature detection section may detect coolant temperature, and the temperature distribution estimation section may estimate the temperature distribution in the machine component from a relationship between the coolant temperature and the temperature of the machine tool if coolant is being discharged, and may estimate the temperature distribution in the machine component from a relationship between revised temperature calculated in the past and the temperature of the machine tool if coolant is not being discharged.

The environmental temperature detection section may detect ambient temperature, and the temperature distribution estimation section may estimate the temperature distribution in the machine component from a relationship between the ambient temperature and the temperature of the machine tool.

According to the present invention, compensation can be performed with high accuracy even in the case where a temperature sensor is separated from a heat source. Moreover, in the case where the difference between the time constants is large, even when thermal displacement occurs in a state in which a temperature change is not detected, the state occurring in an early stage of a transient state, compensation can be performed with high accuracy. Further, a single temperature sensor is sufficient for a machine component, and ambient temperature and the detected temperature of coolant can be shared for use in each machine component. Thus, the number of sensors can be reduced.

### BRIEF DESCRIPTION OF THE DRAWINGS

The forgoing and other objects and feature of the invention will be apparent from the following description of preferred embodiments of the invention with reference to the accompanying drawings, in which:

FIG. 1 is a functional block diagram of a thermal displacement compensation device in an embodiment of the present invention;

FIG. 2 is a view showing an example of the configuration of a machining center for which the thermal displacement compensation device in FIG. 1 calculates a thermal displacement amount;

FIG. 3 is a flowchart showing a procedure for calculating a thermal displacement amount produced by coolant of the machining center shown in FIG. 2, the procedure being executed by the thermal displacement compensation device in FIG. 1;

FIG. 4 is a view showing a calculation model for revised temperature;

FIG. 5 is a graph showing an example of change in the temperature of a column of the machining center;

FIG. 6 is a view showing a calculation model for a thermal displacement amount of the machining center;

FIG. 7 is a flowchart showing a procedure for calculating a thermal displacement amount produced by a change in ambient temperature which is executed on the thermal displacement compensation device in the embodiment of the present invention; and

FIG. 8 is a graph showing temperature at a position separated from a heat source.

### DETAILED DESCRIPTION OF THE PREFERRED EMBODIMENTS

In a thermal displacement compensation device according to the present invention, detected temperature having a time constant different from that of thermal displacement is estimated by solving a heat conduction equation of detected temperature and environmental temperature, and the time constant of detected temperature is revised so as to match the time constant of thermal displacement. With regard to environmental temperature used in this estimation, different values are used according to machine status monitored. For example, in the case where thermal displacement caused by coolant is estimated, a temperature distribution in a casting is estimated, and the time constant of detected temperature of the casting is revised.

In the case where a machine tool is discharging coolant, the heat of coolant flows into the casting. Accordingly, a temperature distribution is estimated from a heat conduction equation on the assumption that the temperature of one end of the casting is the temperature of coolant and that the temperature of other end thereof is the temperature of the casting. From the estimated temperature distribution, temperature having a time constant matching that of thermal displacement is selected, and the selected temperature is used as a revised temperature.

In the case where the machine tool stops discharging coolant, the estimated temperature distribution having a steep temperature slope is uniformized to original temperature of the casting. Accordingly, by estimating a temperature distribution for the case where the temperatures of both ends of the casting are the temperature of the casting, the time constant of detected temperature is matched with the time constant of thermal displacement.

### <1. Configuration>

FIG. 1 is a functional block diagram of a thermal displacement compensation device in one embodiment of the present invention.

A thermal displacement compensation device 100 may be constructed by adding a thermal displacement compensation function to a controller for controlling a machine tool, or may be constructed using an external computer with a thermal displacement compensation function which is connected to a controller for controlling a machine tool. This thermal displacement compensation device 100 includes an environmental temperature detection section 110, a machine temperature detection section 120, a temperature distribution estimation section 130, a position setting section 140, and a thermal displacement amount calculation section 150.

The environmental temperature detection section 110 is functional means including temperature sensors for detecting temperature around a machine for which a thermal displacement amount is to be calculated, and the machine temperature detection section 120 is functional means including temperature sensors for detecting the temperature of each section of the machine (for which a thermal displacement amount is to be calculated). As temperature sensors constituting the environmental temperature detection section 110 or the machine temperature detection section 120, a thermistor temperature sensor, which has resistance to disturbance and is less prone to aging, is generally used, but a contact one formed by bimetal, a thermocouple, or the like or a non-contact one utilizing thermal radiation or the like may also be used.

The temperature distribution estimation section 130 estimates a temperature distribution in a machine component affected by environmental temperature, by a method described in the after-mentioned “<2.1. Revised Temperature Calculation Method>”, based on environmental temperature around the machine detected by the environmental temperature detection section 110 and the detected temperature of the machine detected by the machine temperature detection section 120.

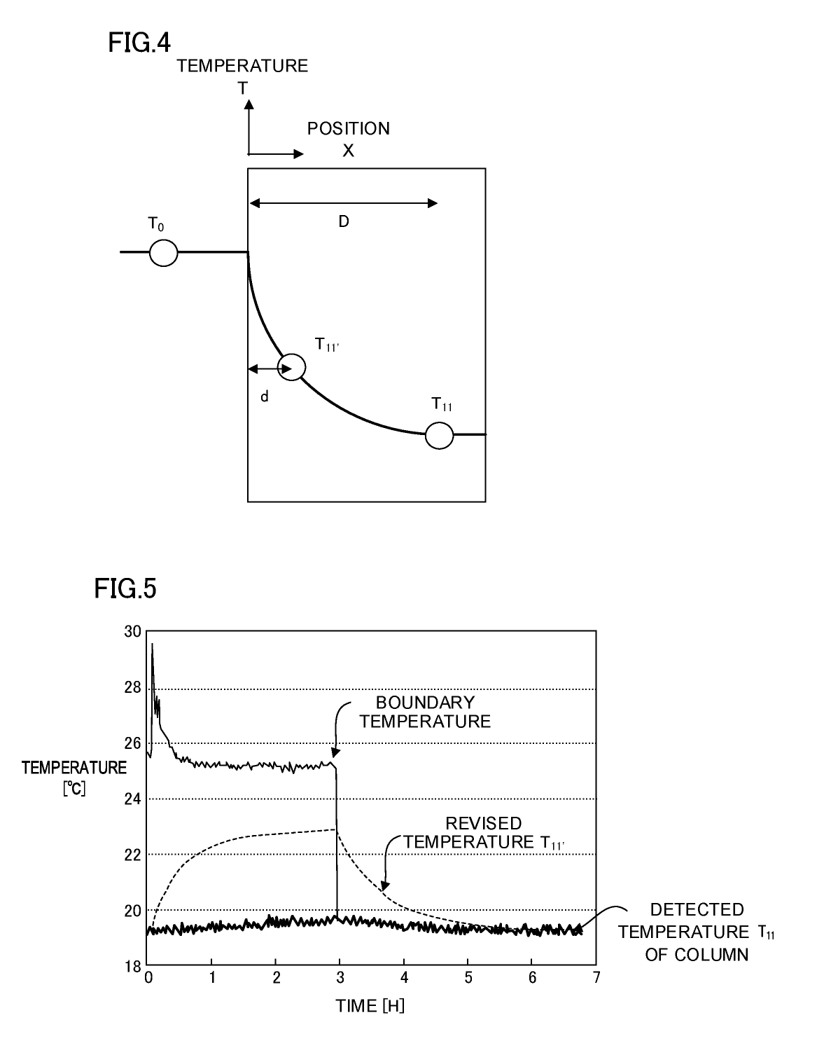

The position setting section 140 finds and sets a machine position (d in FIG. 4) at which the time constant of detected temperature matches the time constant of thermal displacement of the machine component affected by environmental temperature detected by the environmental temperature detection section 110, by a method described in the after-mentioned “<2.1. Revised Temperature Calculation Method>”, based on the temperature distribution in the machine estimated by the temperature distribution estimation section 130. The machine position at which the time constant of detected temperature matches the time constant of thermal displacement may be experimentally determined and set in advance, or may be set in a screen for adjustment or in a machining program.

The thermal displacement amount calculation section 150 sets temperature at the machine position set by the position setting section 140 as a revised temperature of the temperature detected by the machine temperature detection section 120, and then calculates a thermal displacement amount of the machine component by a method described in the after-mentioned “<2.2. Thermal Displacement Amount Calculation Method>”.

Hereinafter, the operation of the thermal displacement compensation device 100 in FIG. 1 having the above-described configuration will be described.

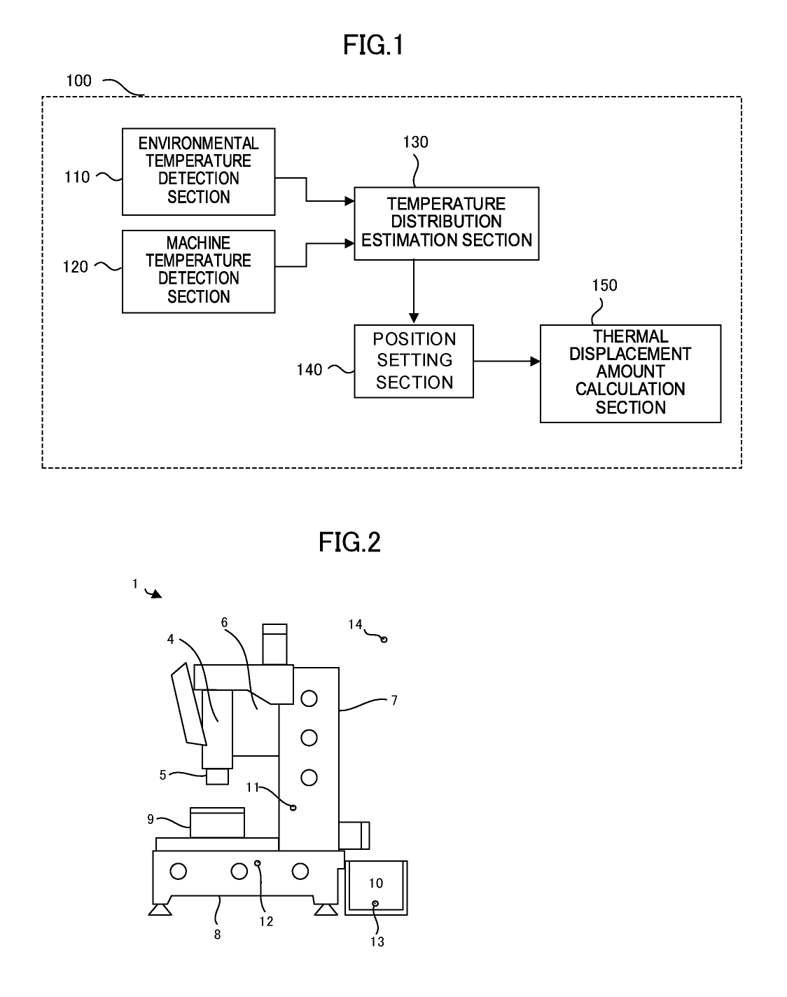

FIG. 2 is a view showing an example of the configuration of a machining center for which the thermal displacement compensation device 100 in FIG. 1 calculates a thermal displacement amount. It should be noted that the thermal displacement compensation device according to the present invention can be applied not only to machining centers but also to machine tools such as injection molding machines and electric discharge machines.

The machining center 1 includes, as is well known, a spindle head 5, a spindle mounting base 6, a spindle 4, a column 7, a bed 8, a movable table 9, a coolant tank 10, and the like. Moreover, a temperature detection section is provided in this machining center 1. For example, a temperature sensor 11 is installed on the column 7, a temperature sensor 12 is installed on the bed 8, a temperature sensor 13 for detecting coolant temperature is installed in the coolant tank 10, and a temperature sensor 14 for detecting ambient temperature is installed outside the machining center 1. In this specification, temperature detected by temperature sensors which are not installed on a main body of the machine tool, such as the temperature sensors 13 and 14, are referred to as “environmental temperature”.

Thermal displacements include ‘active thermal displacements’ caused by frictional heat generated by axis movement and spindle rotation and heat generated by motors and ‘passive thermal displacements’ caused by a change in ambient temperature and the discharge of coolant. ‘Active thermal displacements’ depends on the configuration of the machine tool in a single uniform way, and can be estimated from the operation of the machine. Meanwhile, ‘passive thermal displacements’ differs depending on the environment in which the machine tool is placed, and therefore estimation from the operation of the machine is difficult.

Accordingly, in the present embodiment,
(a) a thermal displacement amount δ_{M} of a ball screw or a spindle portion which is produced by frictional heat or heat generated by a motor is estimated by a publicly-known method disclosed in Japanese Patent Application Laid-Open No. 2002-018677 and the like without using a temperature sensor, and
(b) a thermal displacement amount δ_{E} produced by a change in ambient temperature or coolant is found using a method of the present invention.

### <2. Estimation of Thermal Displacement Caused By Coolant (Embodiment 1)>

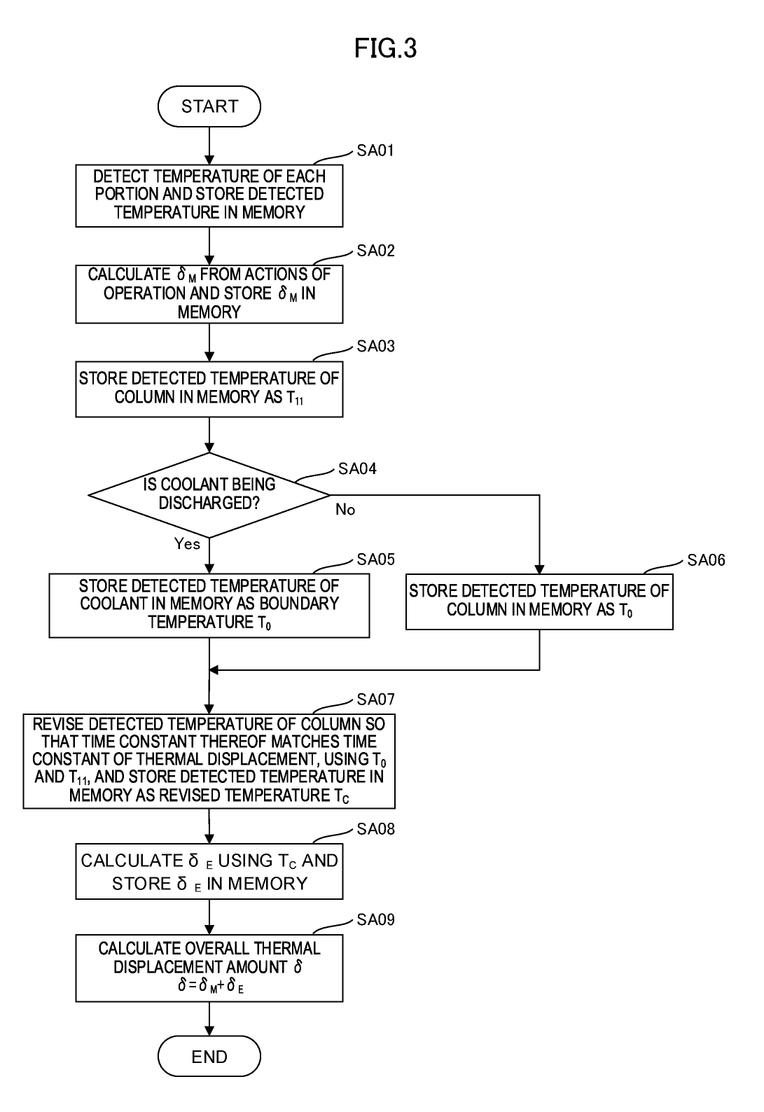

A procedure for estimating thermal displacement caused by the coolant of the machining center 1 shown in FIG. 2, the procedure being executed by the thermal displacement compensation device 100 in FIG. 1, will be described using a flowchart shown in FIG. 3.

A process of the flowchart in FIG. 3 is repeated during a period in which a thermal displacement compensation function is in effect. This flowchart will be described by narrowing down a thermal displacement amount δ_{E} produced by a change in ambient temperature and coolant to the thermal displacement of the column 7. Thermal displacements of machine components such as the bed 8 and the spindle mounting base 6 can also be estimated by a similar method and combined.

[Step SA01] The temperature of each section is detected by a temperature sensor and stored in memory. The temperature is desirably detected at time intervals equal to or shorter than a calculation interval of a thermal displacement amount δ_{M} of the ball screw and the spindle portion. In the case where the detection is performed at intervals shorter than the above-described calculation interval of δ_{M}, the calculation interval is adjusted by a statistical technique such as moving average.

[Step SA02] A thermal displacement amount δ_{M} of the ball screw and the spindle portion is calculated (estimated) from actions of operation by a known method disclosed in the aforementioned Japanese Patent Application Laid-Open No. 2002-018677 and the like which estimates a thermal displacement amount from the operation of the machine, without using a temperature sensor, and a result of the calculation is stored in memory.

[Step SA03] The detected temperature (detected in step SA01) of the column 7, which is a machine component splashed with coolant, is stored in memory as a detected temperature T₁₁ of the column 7.

[Step SA04] A determination is made as to whether or not the machining center 1 is discharging coolant. If the machining center 1 is discharging coolant, the process proceeds to step SA05. If the machining center 1 is not discharging coolant, the process proceeds to step SA06.

[Step SA05] The detected temperature of coolant detected in step SA01 is stored in memory as a boundary temperature T₀ for use in the calculation of a revised temperature, and the process proceeds to step SA07. This boundary temperature T₀ is the temperature of a surface of the column 7 at which the column 7 and coolant contact each other.

[Step SA06] The detected temperature T₁₁ of the column 7 is stored in memory as a boundary temperature T₀ for use in the calculation of a revised temperature, and the process proceeds to step SA07. The boundary temperature T₀ is the surface temperature of the column 7. In the case where coolant is not being discharged, the temperature of the column 7 gradually returns to the original temperature of the column 7, and is therefore replicated by storing the detected temperature T₁₁ of the column 7 as a boundary temperature T₀. Alternatively, ambient temperature may be stored as a boundary temperature T₀.

[Step SA07] The detected temperature T₁₁ of the column 7 is revised so that the time constant thereof may match the time constant of thermal displacement, by an after-mentioned method of calculating a revised temperature, using the boundary temperature T₀ and the detected temperature T₁₁ of the column 7 stored in memory. The calculated temperature is stored in memory as a revised temperature T_{C}.

[Step SA08] A thermal displacement amount δ_{E} produced by coolant is calculated from the revised temperature T_{C} stored in memory in step SA07, by an after-mentioned method of calculating a thermal displacement amount, and is stored in memory.

[Step SA09] The thermal displacement amount δ_{M} of the ball screw and the spindle portion calculated in step SA02 and the thermal displacement amount δ_{E} produced by coolant calculated in step SA08 are read from memory and added up as in the following equation (2) to calculate an overall thermal displacement amount δ.

δ=δ_{M}+δ_{E} (2)

It should be noted that a thermal displacement amount δ may be calculated by preparing coefficients K_{M} and K_{E} for adjustment, multiplying respective thermal displacement amounts by the coefficients as in the equation (3) below, and then adding up the results. Fine adjustment can be performed by measuring an actual thermal displacement amount with a position sensor such as a touch probe and determining the coefficients K_{M} and K_{E} such that an estimation error becomes small.

δ=K_{M}·δ_{M}+K_{E}·δ_{E} (3)

Of course, a common coefficient K can be used as the coefficients K_{M} and K_{E} as in the equation (4) below, or a constant K can be added to the sum of the thermal displacement amounts δ_{M} and δ_{E} which are not multiplied by a coefficient K as in the equation (5). Thus, simplified adjustment can also be appropriately performed.

δ=K(δ_{M}+δ_{E}) (4)

δ=δ_{M}+δ_{E}+K (5)

By the above-described process, an overall thermal displacement amount δ can be estimated. Accordingly, an amount canceling out the thermal displacement amount δ is used as a thermal displacement compensation amount, and an offset is set using a function of the machine tool which adjusts a reference position, such as a machine origin shift function, to perform thermal displacement compensation.

### <2.1. Revised Temperature Calculation Method>

In the case where the position of a temperature sensor installed on a machine component is separated from a heat source, the detection of a temperature change by the temperature sensor is delayed even if the machine component is heated and thermally displaced. Then, a thermal displacement of the machine component cannot be correctly estimated from the temperature detected by the temperature sensor. This phenomenon is expressed as ‘the time constant of thermal displacement and the time constant of detected temperature are different’. However, a thermal displacement can be correctly estimated by calculating a revised temperature T_{C} obtained by matching the time constant of thermal displacement with the time constant of detected temperature by a method described below and estimating a thermal displacement using the revised temperature T_{C} instead of a detected temperature. As an example, a method of calculating a revised temperature T_{C} of the column 7 will be described.

When the discharge of coolant is started, coolant flows over the surface of the column 7, and the heat of the coolant propagates toward the inside of the column 7. In the present embodiment, a simple model concerning the propagation of heat is created with respect to this phenomenon as shown in FIG. 4, and a revised temperature T_{C} is calculated using a first-order heat conduction equation. During the discharge of coolant, coolant temperature is stored as the boundary temperature T₀ according to the aforementioned process of the flowchart in FIG. 3 (step SA05). The temperature of the column surface is assumed to be equal to the coolant temperature, and a temperature distribution T₁₁(x, t)′ between temperature detection points of the column 7 is estimated. From the model in FIG. 4, a heat conduction equation and boundary conditions are set as in the following equation (6):

$$\frac{\partial {T}_{11}^{′}}{\partial t} = β \frac{{\partial }^{2} {T}_{11}^{′}}{\partial {x}^{2}} \\ {{T}_{11} ( 0 , t )}^{′} = {T}_{0} , {{T}_{11} ( D , t )}^{′} = {T}_{11} \qquad ( 6 )$$

Here, t is time, β is temperature diffusion rate, x is position, T₀ is boundary temperature, D is the distance between a heat source and a temperature sensor, and T₁₁ is the detected temperature of the column 7. In the controller, a temperature distribution is calculated by finding a numerical solution of a partial differential equation.

If the depth from the column surface is denoted by d (x=d), temperature at the position can be calculated as T₁₁(d, t)′ from the found temperature distribution T₁₁(x, t)′. An experiment is carried out in advance by, for example, performing machining with coolant discharged, and d (depth d from the column surface) is determined such that the time constant of T₁₁(d, t)′ becomes a time constant which matches actual change in thermal displacement. T₁₁(d, t)′ at this time is a revised temperature T_{C}. Although d is experimentally determined in advance in this example, d can also be changed in a display screen or a machining program for adjustment.

FIG. 5 shows a graph of change in the temperature of the column 7.

In this example, coolant having a temperature adjusted to 25° C. is discharged for three hours, and then the discharge of coolant is stopped. On the graph in FIG. 5, boundary temperature, detected column temperature T₁₁, and calculated revised temperature T₁₁′ are drawn. The detected column temperature T₁₁ changes little while the boundary temperature abruptly changes. However, the calculated revised temperature T₁₁′ immediately changes in response to a change in the boundary temperature. Moreover, though the boundary temperature increases to a high temperature above the adjusted temperature for a moment, the calculated revised temperature T₁₁′ successfully represents the property of a casting to be resistant to the influence of a momentary temperature change.

For simplified calculation, the revised temperature T₁₁′ can also be calculated as the equation (7) below by linear interpolation between the boundary temperature T₀ and the detected column temperature T₁₁. Here, A is a distance to a position at which a temperature is to be found from the detected temperature T₁₁, whereas B is a distance to a position at which a temperature is to be found from the boundary temperature T₀. In this case, calculation is easy but undesirable because the revised temperature is directly affected by noise in the boundary temperature to reduce accuracy.

$${T}_{11}^{′} = \frac{{AT}_{0} + {BT}_{11}}{A + B} \qquad ( 7 )$$

It should be noted that while a revised temperature of the column 7 has been described above, the same is true in revised temperatures of machine components such as the bed 8 and the spindle mounting base 6.

### <2.2. Thermal Displacement Amount Calculation Method>

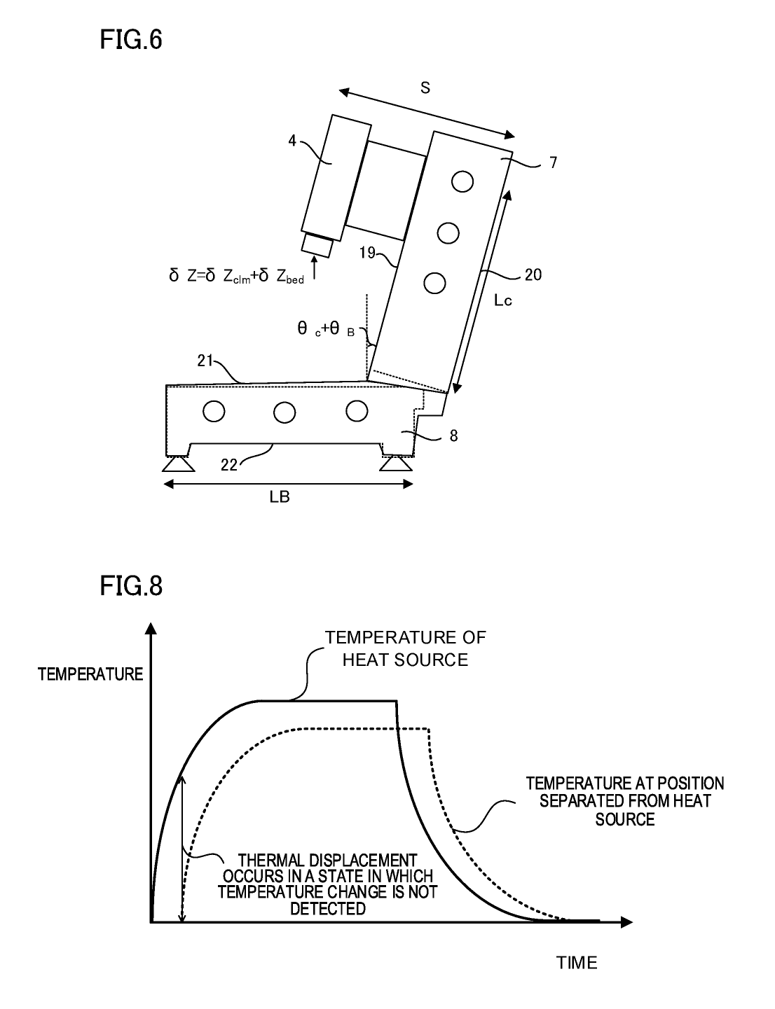

Referring to a side view of the machining center 1 in FIG. 6, the calculation of a thermal displacement amount will be described. In the machining center 1, a thermal displacement caused by a change in ambient temperature and coolant is small in the depth direction because of a symmetric structure.

First, the elongation of each side is calculated using the equation (8) below based on the aforementioned equation (1). For a column inner side 19 and a bed upper side 21 which are splashed with coolant, calculation is performed using calculated revised temperature by the aforementioned method. For a column outer side 20 and a bed lower side 22, which are resistant to the influence of coolant, detected temperature is directly used.

ΔL_{CI}=αL_{C}ΔT₁₁′

ΔL_{CO}=αL_{C}ΔT₂₀

ΔL_{BD}=αL_{B}ΔT₂₂

ΔL_{BU}=═L_{B}ΔT₁₂′ (8)

ΔL_{CI} is the inner elongation of the column 7, ΔT₁₁′ is the amount of change in revised temperature of the column 7, ΔL_{CO} is the outer elongation of the column 7, ΔT₂₀ is the amount of change in detected temperature on an outer portion of the column 7, ΔL_{BD} is the lower elongation of the bed 8, ΔT₂₂ is the amount of change in detected temperature on a lower portion of the bed 8, ΔL_{BU} is the upper elongation of the bed 8, and ΔT₁₂′ is the amount of change in revised temperature of the bed 8. Moreover, L_{C} is the length of the column 7 in the long-side direction, and L_{B} is the length of the bed 8 in the long-side direction.

Then, in the case where the column 7 is assumed to simply incline at a constant angle from a root thereof as shown in FIG. 6, a thermal displacement amount δZ_{clm} in the Z-axis direction produced by the deformation of the column 7 is calculated by, for example, the following equation (9):

$$δ {Z}_{clm} = {L}_{C} ( 1 - cos {θ}_{C} ) - S sin {θ}_{C} \\ tan {θ}_{C} = \frac{( Δ {L}_{CI} + Δ {L}_{CO} )}{{D}_{C}} \qquad ( 9 )$$

In the above-described equation (9), θ_{C} is inclination caused by the deflection of the column 7, S is the distance from the column 7 to a center of the spindle 4, and D_{C} is the length of the column 7 in the short-side direction.

Moreover, if the column 7 is assumed to simply incline at a constant angle from a root thereof due to the elongation of the bed 8, a thermal displacement amount δZ_{bed} in the Z-axis direction caused by the deformation of the bed 8 is calculated by, for example, the following equation (10):

$$δ {Z}_{bed} = {L}_{C} ( 1 - cos {θ}_{B} ) - S sin {θ}_{B} \\ tan {θ}_{B} = \frac{( Δ {L}_{BU} - Δ {L}_{BD} )}{{D}_{B}} \qquad ( 10 )$$

In the above-described equation (10), θ_{B} is the inclination of the column 7 caused by the deflection of the bed 8, and D_{B} is the length of the bed 8 in the short-side direction.

Then, a thermal displacement amount δZ_{E} in the Z-axis direction can be expressed as the following equation (11):

δZ_{E}=δZ_{clm}+δZ_{bed} (11)

It should be noted that thermal displacement is caused by, for example, the elongation of the column, the inclination of the spindle mounting base, and the like as well as the inclination of the column, and accuracy can be further improved by estimating these according to the configuration of the machine tool and adding these to thermal displacement amount. Moreover, a thermal displacement amount in the Y-axis direction can also be calculated similarly, though omitted.

### <3. Estimation of Thermal Displacement Caused by Change in Ambient Temperature (Embodiment 2)>

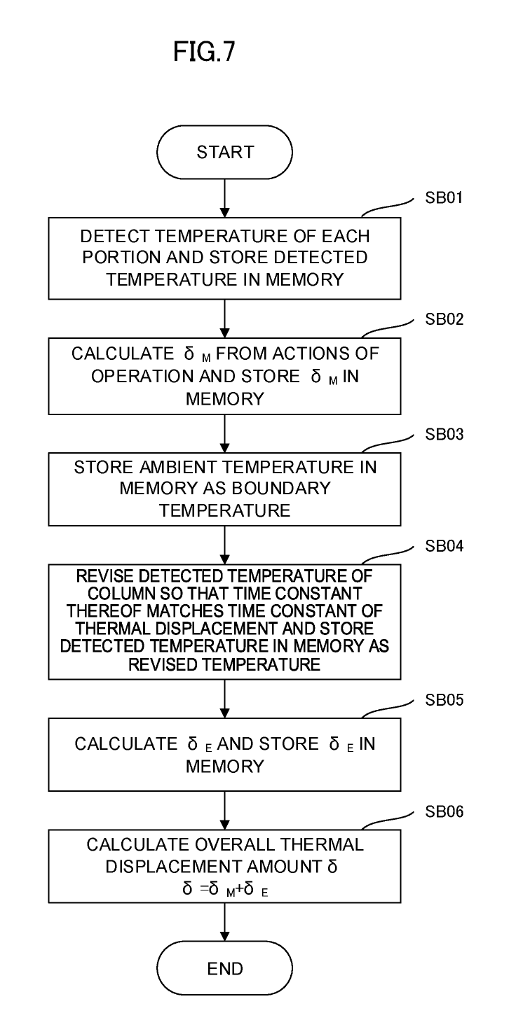

A method of estimating a thermal displacement caused by a change in ambient temperature will be described using a flowchart shown in FIG. 7.

A change in ambient temperature is an overall change unlike coolant. Accordingly, the difference between the time constant of thermal displacement and the time constant of detected temperature is negligible if a temperature sensor is attached to the surface of a casting, but there is a difference between the time constant of thermal displacement and the time constant of detected temperature if a temperature sensor is buried in a casting. Contents which overlap the above description will be omitted in the following description.

[Step SB01] The temperature of each portion is detected by a temperature sensor and stored in memory.

[Step SB02] A thermal displacement amount δ_{M} of the ball screw and the spindle portion is calculated (estimated) from actions of operation by using the aforementioned known method disclosed in Japanese Patent Application Laid-Open No. 2002-018677 and the like which estimates a thermal displacement amount from the operation of the machine without using a temperature sensor, and a result of the calculation is stored in memory.

[Step SB03] The ambient temperature detected by the temperature sensor 14 is stored in memory as a boundary temperature T₀ for use in the calculation of a revised temperature.

[Step SB04] The detected temperature of the column 7 is revised by the aforementioned method of calculating a revised temperature so that the time constant thereof may match the time constant of thermal displacement. A revised temperature can be calculated by a method similar to the aforementioned calculation method by assuming that the surface temperature of the column 7 matches the ambient temperature and that heat propagates inward. The calculated temperature is stored in memory as a revised temperature.

[Step SB05] A thermal displacement amount δ_{E} produced by a change in ambient temperature is calculated by the aforementioned method of calculating a thermal displacement amount and stored in memory. In the case where the ambient temperature changes, the temperature of the casting generally uniformly changes, and accuracy can therefore be improved by estimating the elongation of the casting and adding the elongation to the thermal displacement amount.

[Step SB06] The thermal displacement amount δ_{M} of the ball screw and the spindle portion calculated in step SB02 and the thermal displacement amount δ_{E} produced by a change in ambient temperature calculated in step SB05 are read from memory and added up using the aforementioned equation (2) to calculate an overall thermal displacement amount δ.

While embodiments of the present invention have been described above, the present invention is not limited only to the above-described examples of embodiments, but can be carried out in various aspects by making appropriate modifications thereto.

1. A thermal displacement compensation device for a machine tool, the thermal displacement compensation device including a machine temperature detection section configured to detect temperature of the machine tool and being configured to perform thermal displacement compensation by calculating a thermal displacement amount based on change in temperature measured by the machine temperature detection section, setting an amount canceling out the calculated thermal displacement amount as a thermal displacement compensation amount, and adding the thermal displacement compensation amount to a position command for a feed shaft, the thermal displacement compensation device comprising:
an environmental temperature detection section for detecting temperature of an environment in which the machine tool is placed;
a temperature distribution estimation section for estimating a temperature distribution in a machine component affected by the temperature of the environment from a relationship between the temperature of the environment and the temperature of the machine tool;
a setting section for finding, from the temperature distribution, and setting a position in the machine tool at which a time constant of the detected temperature matches a time constant of thermal displacement of the machine component affected by the temperature of the environment; and
a thermal displacement amount calculation section for calculating a thermal displacement amount of the machine component using temperature at the position set by the setting section as a revised temperature of temperature detected by the machine temperature detection section.

2. The thermal displacement compensation device for the machine tool according to claim 1, wherein
the environmental temperature detection section detects coolant temperature, and
the temperature distribution estimation section
estimates the temperature distribution in the machine component from a relationship between the coolant temperature and the temperature of the machine tool if coolant is being discharged, and
estimates the temperature distribution in the machine component from a relationship between revised temperature calculated in the past and the temperature of the machine tool if coolant is not being discharged.

3. The thermal displacement compensation device for the machine tool according to claim 1, wherein
the environmental temperature detection section detects ambient temperature, and
the temperature distribution estimation section estimates the temperature distribution in the machine component from a relationship between the ambient temperature and the temperature of the machine tool.
